(19) United States
(12) Patent Application Publication
(10) Pub. No.: US 2026/0205158 A1
(43) Pub. Date: Jul. 16, 2026

(54) INTERNET OF THINGS READER AND TAG FREQUENCY HOPPING

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US); Robin HEYDON, Cambridge (GB); Joel LINSKY, San Diego, CA (US)

(21) Appl. No.: 19/017,194

(22) Filed: Jan. 10, 2025

(51) Int. Cl. H04B 1/713

(52) U.S. Cl. CPC H04B 1/713

(57) ABSTRACT

Systems and techniques are described herein for wireless communication. For example, a computing device can determine to configure one or more internet of things (IoT) tags for frequency hopping based on an amount of channel interference of an IoT reader at a first frequency. The computing device can adjust, using a first signal including an indication for frequency hopping, an output frequency of the one or more IoT tags based on the amount of channel interference. The computing device can transmit a message to the one or more IoT tags using the adjusted output frequency.

### FIELD

Aspects of the present disclosure generally relate to wireless communications. For example, aspects of the present disclosure relate to internet of things (IoT) reader and tag frequency hopping.

### BACKGROUND

Wireless communication systems can provide various telecommunication services such as phone calling, video streaming, messaging, etc. Wireless communication technologies can be classified based on a range of communications. For example, short range wireless communication can be associated with wireless communication technologies for communication over short distances (e.g., within thirty meters). Long range wireless communication can be associated with wireless communication technologies for communication over longer distances (e.g., more than thirty meters). Radio Frequency Identification (RFID) systems are generally classified as short range wireless communication. RFID technologies generally provide wireless transfer of data between a reader (e.g., RFID reader device) and a tag or transponder (e.g., RFID tag). RFID systems can be used for identification, tracking, data storage, etc. An internet of things (IoT) device can include RFID technologies. In examples where multiple RFID tags (also referred to as IoT tags when included in an IoT device) and RFID readers (also referred to as IoT readers when included in an IoT device) are deployed in an environment (e.g., a warehouse, department store, etc.), the RFID tags and RFID readers can experience interference when communicating at frequencies within a same frequency band.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for wireless communication is provided. The apparatus includes at least one memory and at least one processor coupled to the at least one memory, the at least one processor configured to: determine to configure one or more internet of things (IoT) tags for frequency hopping based on an amount of channel interference of an IoT reader at a first frequency; adjust, using a first signal including an indication for frequency hopping, an output frequency of the one or more IoT tags based on the amount of channel interference; and transmit a message to the one or more IoT tags using the adjusted output frequency.

In some aspects, a method for wireless communication is provided. The method includes: determining to configure one or more internet of things (IoT) tags for frequency hopping based on an amount of channel interference of an IoT reader at a first frequency; adjusting, using a first signal including an indication for frequency hopping, an output frequency of the one or more IoT tags based on the amount of channel interference; and transmitting a message to the one or more IoT tags using the adjusted output frequency.

In some aspects, a non-transitory computer-readable medium is provided having stored thereon instructions that, when executed by at least one processor, cause the at least one processor to: determine to configure one or more internet of things (IoT) tags for frequency hopping based on an amount of channel interference of an IoT reader at a first frequency; adjust, using a first signal including an indication for frequency hopping, an output frequency of the one or more IoT tags based on the amount of channel interference; and transmit a message to the one or more IoT tags using the adjusted output frequency.

In some aspects, an apparatus for wireless communication is provided. The apparatus includes: means for determining to configure one or more internet of things (IoT) tags for frequency hopping based on an amount of channel interference of an IoT reader at a first frequency; means for adjusting, using a first signal including an indication for frequency hopping, an output frequency of the one or more IoT tags based on the amount of channel interference; and means for transmitting a message to the one or more IoT tags using the adjusted output frequency.

Aspects generally include a method, apparatus, system, computer program product, non-transitory computer-readable medium, user equipment, base station, wireless communication device, and/or processing system as substantially described herein with reference to and as illustrated by the drawings and specification.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating components of a user device computing system, in accordance with aspects of the disclosure;

FIG. 2 is a diagram illustrating an example of a radio frequency (RF) energy harvesting device, in accordance with aspects of the disclosure;

FIG. 3 is a diagram illustrating an example of a radio frequency identification (RFID) system, in accordance with aspects of the disclosure;

FIG. 4 is a block diagram illustrating an example wireless communication network, in accordance with aspects of the disclosure;

FIG. 5 is a diagram illustrating an example of a wireless communication of an IoT reader and IoT tag, in accordance with aspects of the disclosure;

FIG. 6 is a flow diagram illustrating an example of a process for wireless communications, in accordance with some examples; and

FIG. 7 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication systems can provide various telecommunication services such as phone calling, video streaming, messaging, etc. Wireless communication technologies can be classified based on a range (e.g., distance) of communications. For example, short range wireless communication can be associated with wireless communications over short distances (e.g., within thirty meters). Long range wireless communication can be associated with wireless communication over longer distances (e.g., more than thirty meters). Radio Frequency Identification (RFID) systems are generally classified as short range wireless communication technologies. RFID technologies generally provide wireless transfer of data between a reader (e.g., RFID reader device) and a tag or transponder (e.g., RFID tag). RFID systems can be used for identification, tracking, data storage, etc.

An internet of things (IoT) device can include RFID technologies. In examples where multiple RFID tags (also referred to as IoT tags when included in an IoT device) and RFID readers (also referred to as IoT readers when included in an IoT device) are deployed in an environment (e.g., a warehouse, department store, etc.), the RFID tags and RFID readers can experience interference when communicating at frequencies within a same frequency band.

IoT tags (or RFID tags) generally include data storage and an antenna. For example, the data storage can store information corresponding to an item (e.g., the item with the RFID included or affixed). In such an example, the information can include an identifier of the item such as a name, an electronic product code (EPC), a serial number, manufacturer, etc. The antenna can enable wireless communication (transmission of commands and data) from the IoT tag, or for the IoT tag to be read by an IOT reader. IOT tags can be powered by the IOT reader. For example, an interrogating signal from the IOT reader (e.g., a signal from the IOT reader to read an IOT tag or request information from an IOT tag) can be used to power the IOT tag.

Long range wireless communication can be achieved using telecommunications networks, such as 5G networks. As telecommunications networks expand into industrial verticals and the quantity of deployed IoT devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices” (e.g., A-IoT devices) or simply as “passive devices”. For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

In some examples, ambient IoT devices (e.g., active IoT devices, passive IoT devices, semi-passive IoT devices, etc.) are relatively low-cost devices that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. (e.g., to monitor, track, and locate items associated with the passive IoT devices). Passive and semi-passive IoT devices can include one or more sensors, a processor or micro-controller, and an energy harvester for generating electrical power from incident downlink radio frequency (RF) signals received at the passive or semi-passive IoT device. Energy harvesting devices can be deployed at large scales, based on the simplification in their manufacture and deployment associated with implementing wireless energy harvesting.

Currently, passive devices, such as in the form of electronic tags (e.g., IoT tags or RFID tags), are a rapidly growing technology impacting many industries, due to their economic potential for inventory and/or asset management inside and outside warehouses, IoT devices, sustainable sensor networks in factories and/or agriculture, and smart home usage. Electronic tags may include small transponders, or tags, that emit an information-bearing signal after receiving a signal.

Energy harvesting devices (e.g., electronic tags such as IOT tags) can harvest energy over-the-air to power their transmission and reception circuitry. For example, in some cases, energy harvesting devices can harvest energy from ambient downlink RF signals (e.g., including dedicated downlink RF signals for energy harvesting and various other downlink RF signals that are not dedicated energy harvesting signals). Based on harvesting energy from incident downlink radio frequency (RF) signals (e.g., transmitted by a network device, such as a reader device or an interrogator), ambient energy harvesting devices (e.g., passive IoT devices, which may be in the form of electronic tags such as IoT tags) may be provided without an energy storage element and/or can be provided with a relatively small energy storage element (e.g., battery, capacitor, etc.). For example, energy harvesting devices (e.g., electronic tags) can operate without a battery at a low operating expense (OPEX), with a low maintenance cost, and with a long-life cycle. Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In a wireless communication environment, a device (e.g., such as a reader device or interrogator) can be used to transmit downlink RF signals to energy harvesting devices. In one illustrative example, a reader device can read and/or write information stored on energy harvesting IoT devices (e.g., electronic tags, which may each be associated with a respective item) by transmitting the downlink RF signal. The downlink RF signal can provide energy to an energy harvesting IoT device. The energy harvesting IoT device can transmit (e.g., based on reflecting or backscattering a portion of the incident downlink RF signal) a response signal (e.g., an information-bearing uplink signal) back to the reader device, after the energy harvesting IoT device is sufficiently energized based on the downlink RF signal. The reader device can read the signal transmitted by an energy harvesting IoT device to decode the information transmitted by the IoT device (e.g., such as sensor information collected by one or more sensors included in the IoT device, etc.).

In some cases, an energy harvesting device can use the same antenna for energy harvesting and communications. For example, an energy harvesting device can use the same antenna to perform energy harvesting and backscatter communications, where the energy harvesting and the backscatter communications are based on the same downlink RF signal. In some examples, an energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

A backscatter transmitter of an energy harvesting device can generate and transmit an uplink signal (also referred to as a backscatter signal) by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a reader device or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

In some examples, for a given downlink signal with a given input RF power received at an ambient energy harvesting device, a first portion of the input RF power is provided to the device's energy harvester (e.g., with a percentage being converted to useful electrical power based on the conversion efficiency of the harvester, and the remaining percentage dissipated as heat, etc.). A remaining, second portion of the input RF power is available for use in the backscattered uplink transmission (e.g., the second portion of the input power is reflected and modulated with the uplink communication).

An energy harvesting tag (EH-tag) system is an ambient IoT system. The system generally includes an energizer (e.g., a reader device or interrogator) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform (CW)) to the electronic tags.

An example of an energy harvesting device (e.g., tag) is an IoT tag (or RFID tag). RFID systems are generally classified as short range wireless communication. RFID technologies provide wireless transfer of data between a reader (e.g., IoT reader device) and a tag or transponder (e.g., IoT tag). RFID systems (or IoT systems including RFID technologies) are generally used for identifying, inventorying, and tracking information associated with tagged physical objects (e.g., a box in a warehouse, items in a store, etc.).

RFID systems can be used for wireless communication between a reader device (e.g., RFID reader or IoT reader) and one or more tags or transponders (e.g., IoT tags). An IoT reader may also be referred to as an “IoT interrogator,” and “IoT scanner,” and/or an “energizer.” RFID systems can be used to identify and/or track various items that are associated with one or more IoT tags (e.g., various items to which one or more IoT tags are attached). IoT systems can read and/or write information to and/or from (respectively) IoT tags, based on respective wireless communications between an IoT reader and the IoT tags.

For example, an IoT reader (e.g., energizer, RFID reader of an IoT reader) can be used to interrogate one or more IoT tags to obtain information of the nearby items that are within communication range of the IoT reader and the interrogation signal. The IoT reader (e.g., energizer) can transmit an RF signal to perform the energizing and interrogating of the IoT tags. An IoT tag that receives the interrogating RF wave can respond by backscattering (e.g., reflecting back) and/or transmitting another RF wave, as previously described. An IoT tag may generate the responsive RF wave originally (e.g., in examples where the IoT tag is an active or semi-active tag). An IoT tag may generate the responsive RF wave passively, for instance by reflecting back a portion of the interrogating RFID wave using a backscatter process (e.g., in examples where the IoT tag is a passive tag). The responsive RF wave can be referred to as the immediate IoT tag reply.

An IoT tag attached to a respective item, or attached to a group of items, can store corresponding information thereof. For example, an IoT tag can include a data storage element that stores information corresponding to the item(s) to which the IoT tag is attached and associated. For instance, IoT tag information can include one or more of a product name, a serial number, product information, a manufacturer, etc. In some examples, the IoT tag can store identification information that is directly indicative of a tagged item, product, object, etc. For instance, an IoT tag can store identification information such as a unique product serial number, etc. In some examples, the IoT tag does not store product or item identification information directly, and stores a unique IoT tag serial number or identification number which may be externally mapped to various item identification information such as product serial numbers, product names, product SKUs, etc. An IoT reader (e.g., energizer) can transmit an RF signal configured to cause the IoT tags to transmit at least a portion of their respective identification information. The IoT reader can receive (e.g., scan) the identification information transmitted by the one or more IoT tags energized by the IoT reader and can use the identification information to track inventory of tagged items or products that are within range of the RF signal of the IoT reader (e.g., nearby such as within 30 meters).

IoT readers can be configured to read a large number (e.g., dozens, hundreds, or other number) of IoT tags per second, based on the respective IoT tags responding to an interrogation signal from the IoT reader using a corresponding time slot determined for the respective IoT tag. The time slot used by an IoT tag can be assigned by the IoT reader or can be determined by the IoT tags.

A plurality of IoT tags and IoT readers may be used to perform inventorying actions. In some examples, the use of multiple IoT tags and IoT readers can cause interference between various devices as the IoT readers and IoT tags transmit signals, messages, responses etc. For example, a general use of IoT tags and IoT readers is to track inventory of goods in a warehouse. An enclosed space such as a warehouse with various IoT tags, IoT readers, and other devices generating signals can cause signal interference at communication channels (e.g., signal frequency bands) used by the IoT readers and the IoT tags. Interference can prevent accurate inventorying of IoT tags. In such an example, communication channels of the IoT readers and IoT tags can become encumbered with interference causing errors in communication between IoT tags and IoT readers. The errors can include causing IoT readers to incorrectly determine a number of IoT tags within an area, causing IoT tags to not detect messages from an IoT reader, etc.

IoT tags and IoT readers can be configured to communicate using various frequencies. For example, IoT tags and IoT readers can communicate using low frequency (e.g., 125 kilohertz KHz to 135 KHz), high frequency (3 megahertz MHz to 30 MHz), ultra-high frequency (e.g., 860 MHz to 960 MHz), and various other frequency ranges greater than or less than the aforementioned frequency ranges. In some cases, an energy harvesting system can coexist with other wireless systems. For example, the energy harvesting system may include energizers and energy harvesting devices. The energy harvesting devices and/or energizers may operate in public bands (e.g., unlicensed spectrum such as 2.4 gigahertz GHz, 900 MHz, 5 GHz, etc.) and other nearby devices may also operate on the same public bands. In some cases, some public bands, such as 2.4 GHz, can be crowded as many other devices may also use the public bands. In some cases, it may be useful to allow an energy harvesting device, in addition to transmitting on a fixed frequency of a public band, to hop frequencies (e.g., channels) within the public band to help avoid/mitigate interference.

Systems, apparatuses, electronic devices, methods (also referred to as processes), and computer-readable media (collectively referred to herein as “systems and techniques”) are described herein for wireless communication. For example, the systems and techniques are described herein for wireless communication between IoT readers and IoT tags using dynamic frequency adjustment of signals, messages, responses, etc. of IoT tags and IoT readers. For example, the systems and techniques can include determining whether to transition IoT tags and IoT readers from communicating using a first frequency range (e.g., output frequency, frequency band, channel frequency) based on an amount of signal interference.

Signal interference can be represented based on signal strength of signals, messages, responses, packets, etc. transmitted by IoT tags and IoT readers. In some cases, the signal strength can be indicated by a signal strength indicator (e.g., a received signal strength indicator (RSSI)). In some cases, signal strength indicators can include or can be associated with an amount of signal interference (e.g., represented in decibels (dB)). An IoT reader can monitor signal strength indicators of one or more channels (e.g., frequency bands, frequency channels, etc.). In such an example, the IoT reader can measure a dB level of the interference over a predetermined period of time to determine an average strength of the interference. In another example, the IoT reader can monitor a maximum detected strength of interference (e.g., a highest detected strength of the interference over the predetermined period of time). The maximum detected strength can be dependent on the IoT devices (e.g., A-IoT devices) sensitivity. For example, when the IoT device can tolerate interference level 3 dB below a transmission signal level, the threshold can be determined based on the IoT reader transmission power and the IoT reader range (e.g., reading range), the threshold of the interference level can be decided.

In some aspects, the systems and techniques can include determining to configure the IoT tags for frequency hopping based on the average strength of the interference. For example, the systems and techniques can include comparing the level of signal strength indicators (e.g., the strength of interference) to a predetermined interference threshold. When the strength of interference exceeds the predetermined interference threshold, the systems and techniques can include configuring the IoT tags to frequency hopping (e.g., a frequency hopping mode or frequency hopping state). In some examples, when the strength of interference does not exceed the interference threshold, the systems and techniques can communicate using an initial frequency (e.g., performing operations using an initial signal frequency or fixed channel).

In another example, the systems and techniques can include determining to configure the IoT tags for frequency hopping based on frequency band occupancy of the IoT reader. Frequency band occupancy can refer to a range of signal frequencies in use by a wireless communication device or other device in an environment (or ambient signal frequencies). The frequency occupancy band can be based on a portion of a range of frequencies within the band including transmitted or ambient signals. For example, the frequency band occupancy can be based on the percentage of available frequencies (e.g., unused frequencies) with the frequency band. The percentage of available frequency band occupancy can be based on a comparison of the amount of interference (e.g., other devices transmitting signals at frequencies within the band) over a total availability of the frequency band occupancy to a predetermined interference threshold.

In some aspects, the systems and techniques can include adjusting an output frequency of the IoT reader and the IoT tags. For example, the systems and techniques can include transmitting a signal to the IoT tags including an indication for frequency hopping. In some examples, the signal can be part of a signal for powering the IoT tag (e.g., when the IoT tag is a passive tag powered by the IoT reader or another energizer). For example, the signal can be a wake-up signal to set an output frequency of the IoT tags.

In some aspects, the systems and techniques can include transmitting a message to IoT tags using the adjusted output frequency. For example, the IoT tags can be configured using the signal transmitted to the IoT readers to receive the adjusted output frequency. The IoT tags and the IoT reader can perform various operations (e.g., inventorying operations) using the adjusted output frequency. For example, the IoT reader can transmit a message to the IoT tags using the adjusted output frequency and can receive a response (e.g., a response in reply to the message) using the adjusted output frequency.

In some aspects, the systems and techniques can include selecting a channel frequency band from a plurality of channel frequency bands based on the amount of interference. In some examples, the systems and techniques can include monitoring multiple channel frequency bands to determine a channel frequency band which has interference below an interference threshold (e.g., a signal strength or frequency band occupancy below the interference threshold). The systems and techniques can include setting the output frequency to a frequency within a channel frequency band having interference below the interference threshold. In some examples, the systems and techniques can include iterating through predetermined channel frequency bands to determine a channel frequency band with interference below the interference threshold.

In some aspects, the systems and techniques can include setting a first plurality of IoT tags and a first IoT reader to output signals, messages, responses, etc. at a first frequency and setting a second plurality of IoT tags and a second IoT reader to output signals, messages, responses, etc. at a second frequency.

Various aspects of the systems and techniques described herein will be discussed below with respect to the figures.

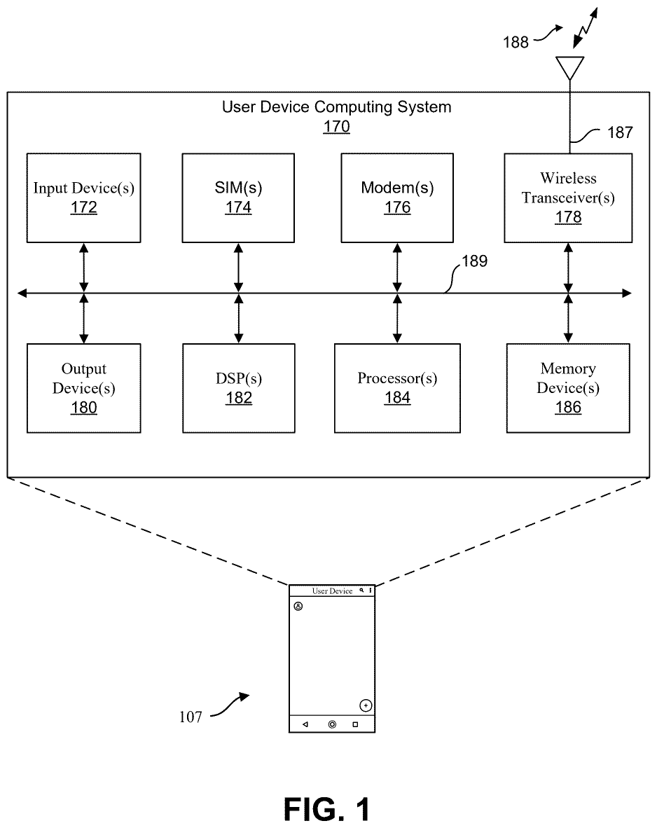

FIG. 1 illustrates an example of a computing system 170 of a wireless device 107. The wireless device 107 may include a client device such as user equipment (UE), and energizing device, or other type of device (e.g., a station (STA) configured to communication using a Wi-Fi interface, wireless local area network (WLAN) STA, etc.) that may be used by an end-user. For example, the wireless device 107 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 170 includes software and hardware components that may be electrically or communicatively coupled via a bus 189 (e.g., or may otherwise be in communication, as appropriate). For example, the computing system 170 includes one or more processors 184. The one or more processors 184 may include one or more central processing units (CPUs), Application-Specific Integrated Circuit (ASICs), Field Programmable Gate Arrays (FPGAs), auxiliary processors, graphics processing unit (GPUs), video processing units (VPUs), native signal processors, microcontrollers, dedicated hardware, any combination thereof, and/or other processing device or system. The bus 189 may be used by the one or more processors 184 to communicate between cores and/or with the one or more memory devices 186.

The computing system 170 may also include one or more memory devices 186, one or more digital signal processors (DSPs) 182, one or more SIMs 174, one or more modems 176, one or more wireless transceivers 178, an antenna 187, one or more input devices 172 (e.g., a camera, a mouse, a keyboard, a touch sensitive screen, a touch pad, a keypad, a microphone, and/or the like), and one or more output devices 180 (e.g., a display, a speaker, a printer, and/or the like).

In some aspects, computing system 170 may include one or more radio frequency (RF) interfaces configured to transmit and/or receive RF signals. In some examples, an RF interface may include components such as modem(s) 176, wireless transceiver(s) 178, and/or antennas 187. The one or more wireless transceivers 178 may transmit and receive wireless signals (e.g., signal 188) via antenna 187 from one or more other devices, such as other wireless devices, network devices (e.g., base stations such as an evolved Node B (eNBs) and/or next generation Node B (gNBs), Wi-Fi access points (APs) such as routers, range extenders or the like, etc.), cloud networks, and/or the like. In some examples, the computing system 170 may include multiple antennas or an antenna array that may facilitate simultaneous transmit and receive functionality. Antenna 187 may be an omnidirectional antenna such that radio frequency (RF) signals may be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 188 may be transmitted directly to other wireless devices using sidelink communications (e.g., using a PC5 interface, using a DSRC interface, etc.). Wireless transceivers 178 may be configured to transmit RF signals for performing sidelink communications via antenna 187 in accordance with one or more transmit power parameters that may be associated with one or more regulation modes. Wireless transceivers 178 may also be configured to receive sidelink communication signals having different signal parameters from other wireless devices.

In some examples, the one or more wireless transceivers 178 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 188 into a baseband or intermediate frequency and may convert the RF signals to the digital domain.

In some cases, the computing system 170 may include a coding-decoding device (or CODEC) configured to encode and/or decode data transmitted and/or received using the one or more wireless transceivers 178. In some cases, the computing system 170 may include an encryption-decryption device or component configured to encrypt and/or decrypt data (e.g., according to the AES and/or DES standard) transmitted and/or received by the one or more wireless transceivers 178.

The one or more SIMs 174 may each securely store an international mobile subscriber identity (IMSI) number and related key assigned to the user of the wireless device 107. The IMSI and key may be used to identify and authenticate the subscriber when accessing a network provided by a network service provider or operator associated with the one or more SIMs 174. The one or more modems 176 may modulate one or more signals to encode information for transmission using the one or more wireless transceivers 178. The one or more modems 176 may also demodulate signals received by the one or more wireless transceivers 178 in order to decode the transmitted information. In some examples, the one or more modems 176 may include a Wi-Fi modem, a 4G (or LTE) modem, a 5G (or NR) modem, and/or other types of modems. The one or more modems 176 and the one or more wireless transceivers 178 may be used for communicating data for the one or more SIMs 174.

The computing system 170 may also include (and/or be in communication with) one or more non-transitory machine-readable storage media or storage devices (e.g., one or more memory devices 186), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The computing system 170 may also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the computing system 170 may be an energizing device (e.g., a reader device, such as a base station, an access point, a handheld reader device, etc.). In some cases, the energizing device may be a computing system 170 configured to transmit a downlink (DL) waveform capable of energizing an energy harvesting device (e.g., an ambient IoT device, such as a passive or semi-passive IoT device). As an example, the energizing device for a Bluetooth low energy (BLE) device may be a BLE device capable of transmitting a BLE signal. In some cases, the BLE signal may have a certain waveform and/or transmit power for certain frequencies, such as 30 dBm (decibels per milliwatt) in 900 MHz ISM band, 20 dBm in 2.4 GHz in the US, and 10 dBm in 2.4 GHz in the EU.

A RF energy harvesting device can harvest RF energy from one or more RF signals received using an antenna. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device can be implemented as an Internet-of-Things (IoT) device, can be implemented as a sensor, etc.

In some cases, an energy harvesting device can be implemented as active or semi-passive energy harvesting device (e.g., also referred to as an active EH-capable device or a semi-passive EH-capable device, respectively). An active/semi-passive energy harvesting device may include one or more energy storage elements (e.g., collectively referred to as an “energy reservoir”). For example, the one or more energy storage elements can include batteries, capacitors, etc. In some examples, the one or more energy storage elements may be associated with a boost converter. The boost converter can receive as input at least a portion of the energy harvested by an energy harvester (e.g., with a remaining portion of the harvested energy being provided as instantaneous power for operating the energy harvesting device) and step up the harvested energy generated by the energy harvester to a voltage level associated with charging the one or more energy storage elements.

In some cases, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

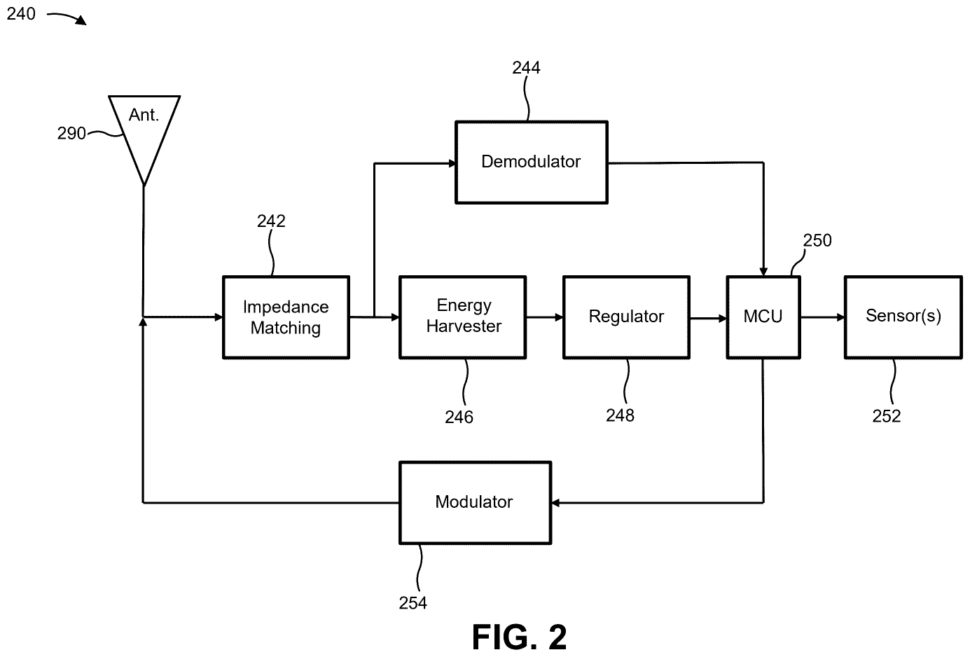

FIG. 2 is a diagram illustrating an example of an architecture of a radio frequency (RF) energy harvesting device 240, in accordance with some examples. As will be described in greater depth below, the RF energy harvesting device 240 can harvest RF energy from one or more RF signals received using one or more antennas 290. As used herein, the term “energy harvesting” may be used interchangeably with “power harvesting.” In some aspects, energy harvesting device 240 can be implemented as an Internet-of-Things (IoT) device, can be implemented as a sensor, etc., as will be described in greater depth below. In other examples, energy harvesting device 240 can be implemented as a Radio-Frequency Identification (RFID) tag or various other RFID devices. In another example, the RFID tag can be part of an IoT device (e.g., an A-IoT device). In such an example, the RFID tag can be referred to as an IoT tag.

The energy harvesting device 240 includes the one or more antennas 290 that can be used to transmit and receive one or more wireless signals. For example, energy harvesting device 240 can use antenna(s) 290 to receive one or more downlink signals and to transmit one or more uplink signals. An impedance matching component 242 can be used to match the impedance of antenna(s) 290 to the impedance of one or more (or all) of the receive components included in energy harvesting device 240. In some examples, the receive components of energy harvesting device 240 can include a demodulator 244 (e.g., for demodulating a received downlink signal), an energy harvester 246 (e.g., for harvesting RF energy from the received downlink signal), a regulator 248, a micro-controller unit (MCU) 250, a modulator 254 (e.g., for generating an uplink signal). In some cases, the receive components of energy harvesting device 240 may further include one or more sensors 252.

The downlink signals can be received from one or more transmitters. For example, energy harvesting device 240 may receive a downlink signal from a network node or network entity that is included in a same wireless network as the energy harvesting device 240. In some cases, the network entity can be a base station, gNB, etc., that communicates with the energy harvesting device 240 using a cellular communication network. For example, the cellular communication network can be implemented according to the 3G, 4G, 5G, 6G, and/or other cellular standard (e.g., including future standards such as 6G and beyond).

In some cases, energy harvesting device 240 can be implemented as a passive or semi-passive energy harvesting device (e.g., an ambient energy harvesting device), which can perform passive uplink communication by modulating and reflecting a downlink signal received via antenna(s) 290. For example, passive and semi-passive energy harvesting devices may be unable to generate and transmit an uplink signal without first receiving a downlink signal that can be modulated and reflected. In other examples, energy harvesting device 240 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

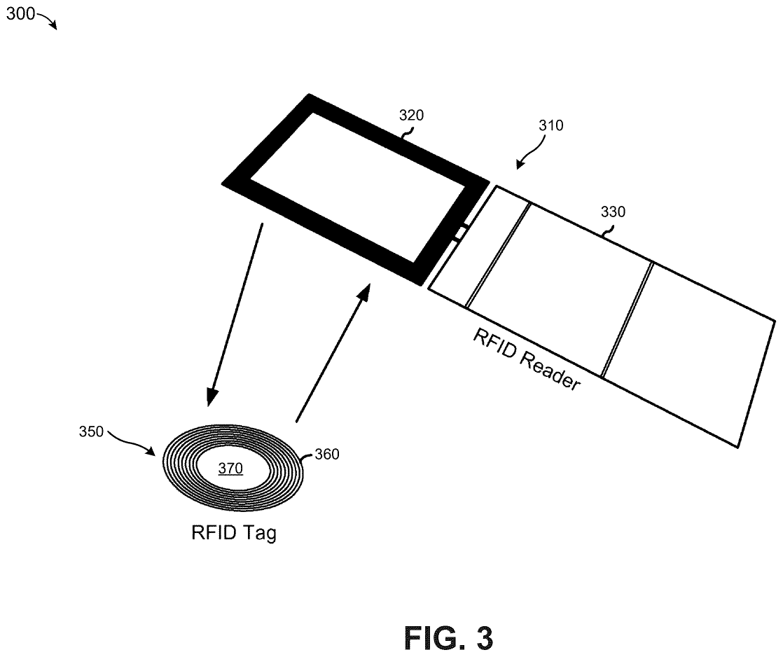

FIG. 3 is a diagram illustrating an example RFID system 300 that includes an RFID reader (e.g., energizer or when the RFID reader is part of an IoT device, IoT reader) 310 and an RFID tag 350. RFID reader 310 may also be referred to as an interrogator, a scanner, an energizer, etc. RFID tag 350 may also be referred to as an RFID label, an electronics label, etc. In examples, where the RFID tag 350 is part of an IoT device, the RFID tag 350 can be referred to as an IoT tag. In examples where the RFID reader 310 is part of an IoT device, the RFID tag 350 can be referred to as an IoT tag. In examples where the IoT device (IoT reader, IoT tag) is a passive device, the IoT device can be referred to as an ambient IoT device (e.g., an A-IoT device, A-IoT reader, A-IoT tag, etc.).

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries.

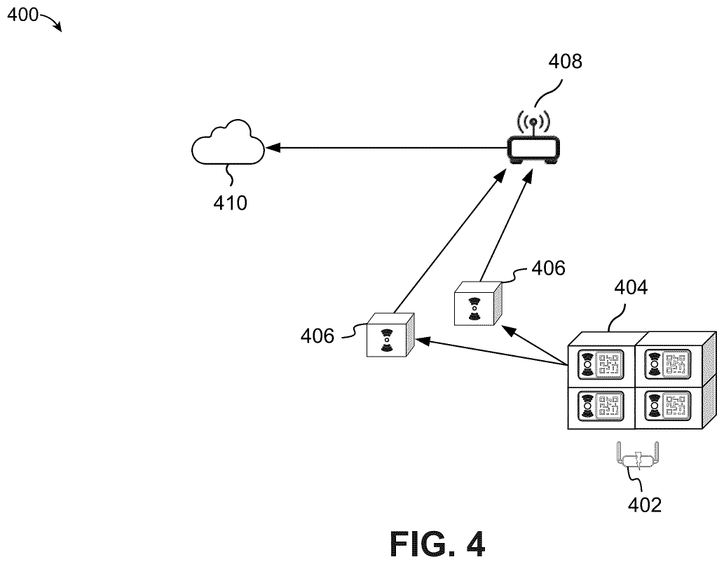

FIG. 4 is a block diagram illustrating an example wireless communication network 400 between one or more of IoT tags 404 and IoT readers 406. By way of example, the IoT tags 404 can be powered by an energizer 402. In some examples, the energizer 402 can be a component of the IoT readers 406. For example, the IoT tags 404 can be passive IoT tags (A-IoT) powered by a signal output by the IoT readers 406.

In some examples, the IoT readers 406 can be part of one or more Bluetooth low energy (BLE) controllers. For example, the BLE controllers can be used to control wireless communications between the IoT readers 406 and the IoT tags 404. For example, the BLE controllers can be used to adjust an output frequency of the IoT readers 406. In some examples, the BLE controllers (or the IoT readers 406) can be used to determine an amount of signal interference in an environment.

For example, the BLE controllers (or the IoT readers 406) can determine an amount of interference associated with a signal frequency or signal frequency band (e.g., range of signal frequencies). In such an example, the IoT readers 406 can measure interference (e.g., in dB) and compare the interference to an interference threshold. In such an example, when the interference exceeds an interference threshold, the IoT readers 406 can transmit a signal to the IoT tags to operate in a frequency hopping mode.

The frequency hopping mode can be a mode or state of the IoT tags 404 to adjust an output frequency of responses from the IoT tags 404. For example, the IoT tags 404 can be configured to output signals, responses, messages, etc. at a plurality of different output frequencies. The IoT tags 404 can receive a signal from the IoT reader 406 including an indication to operate in a frequency hopping mode. In some examples, the signal can include an adjusted signal frequency or frequency band at which the IoT tags 404 can output subsequent signals. For example, the signal from the IoT reader 406 can include an indicator of an adjusted frequency to which subsequent communication between the IoT tags 404 and the IoT reader 406 can be performed.

The IoT readers 406 can adjust an output signal frequency at which the IoT readers 406 and the IoT tags 404 communicate based on the interference. For example, when the interference exceeds the interference threshold (e.g., a predetermined amount of interference within a frequency band), the IoT readers 406 can adjust the output frequency at which communicates with the IoT tags 404. In some examples, output frequency (e.g., the signal frequency at which an IoT reader and IoT tag communicate) can be determined during initialization of communication between the IoT readers 406 and the IoT tags 404. In another example, the output frequency of the IoT readers 406 and the IoT tags 404 can be adjusted between communications or operations of the IoT readers 406 and the IoT tags 404.

In such an example, the IoT tags 404 and the of the IoT readers 406 can perform inventorying operations. The IoT readers 406 can determine during performance of inventorying operations (e.g., including the time before and after transmitting inventorying commands), that the interference at the output frequency (e.g., interference within a frequency band or range including the output frequency) exceeds the predetermined threshold. The IoT readers 406 can output a signal to the IoT tags 404 to output subsequent signals, responses, messages, etc. at an adjusted output frequency (e.g., an output frequency with interference levels below the predetermined threshold).

In some examples, the interference can be based on signal strength indicators (e.g., RSSIs) of the IoT readers 406. In such examples, the signal strength indicators can include or can be associated with an amount of signal interference represented in decibels (dB). The IoT readers 406 can monitor signal strength indicators of one or more frequency bands and determine interference at multiple frequency bands. In such an example, the IoT readers 406 can measure a dB level of the interference at a frequency band over a predetermined period of time to determine an average strength of the interference. In further examples, the IoT readers 406 can monitor changes in interference to detect a highest strength of interference over the predetermined period of time. The IoT readers 406 can compare the average strength of interference or the highest strength of the interference to an interference threshold. When the interference threshold is exceeded, the IoT readers 406 can determine to adjust the output frequency used to communicate with the IoT tags 404. When the interference threshold is not exceeded, the IoT readers 406 can determine to maintain communication with the IoT tags 404 using the output frequency.

In further examples, the IoT readers 406 can determine whether to adjust the output frequency based on frequency band occupancy of the IoT readers 406. For example, the frequency band occupancy can represent a portion of a range of frequencies within a frequency band which include transmitted signals. The frequency band occupancy can be based on of the percentage of available frequency band occupancy. For example, the frequency band occupancy can be determined based on an amount of interference within a frequency band over a total availability of a frequency band. In some examples, the interference threshold can be based on frequency band occupancy. In such an example, the IoT readers 406 can determine to adjust an output frequency based on the frequency band occupancy exceeding the interference threshold. When the frequency band occupancy does not exceed the frequency threshold, the IoT readers 406 can communicate with the IoT tags 404 maintaining the output frequency.

When the IoT readers 406 determine the interference associated with a frequency band (e.g., based on the signal strength indicator, average interference strength, highest interference strength, frequency band occupancy, etc.) exceeds the interference threshold, the IoT readers 406 can transmit a signal to the IoT tags 404 indicating the IoT tags 404 should operate using frequency hopping. For example, frequency hopping can be a mode of operation or state under which the IoT tags 404 can output responses using adjusted output frequencies. For example, the IoT readers 406 can transmit a wake-up signal to the IoT tags 404 including information associated with an output frequency which the IoT tags 404 and the IoT readers 406 can use for subsequent communications.

The IoT readers 406 (or a BLE controller including the IoT readers 406) can communicate with an access point (AP) 408. For example, the AP 408 can be a WiFi router. In some examples, the IoT readers 406 can transmit information such inventorying information associated with inventorying the IoT tags 404 to the AP 408. The AP 408 can be in communication with a cloud service 410 or server. For example, the cloud service 410 can be a management service for tracking inventory. In such an example where the IoT readers 406 and the IoT tags 404 are used in a warehouse, the cloud service 410 can be a product tracking service for tracking products including an IoT tag.

In some examples, the IoT readers 406 can output signals, responses, messages, etc. at different frequencies. For example, a first IoT reader can use a first output frequency to communicate with a first plurality of IoT tags. A second IoT reader can use a second output frequency to communicate with a second plurality of IoT tags. In such an example, the first IoT reader or the second IoT reader can adjust output frequency based on interference. For example, a third IoT reader can be introduced within range of the first IoT reader and using the first output frequency. The first IoT reader can detect interference from the third IoT reader at the first output frequency and interference from the second IoT reader at the second output frequency. When the interference at the first output frequency and the second output frequency exceeds a predetermined interference threshold, the first IoT reader can transmit a signal to the first plurality of IoT tags including an indicator to communicate using a third output frequency.

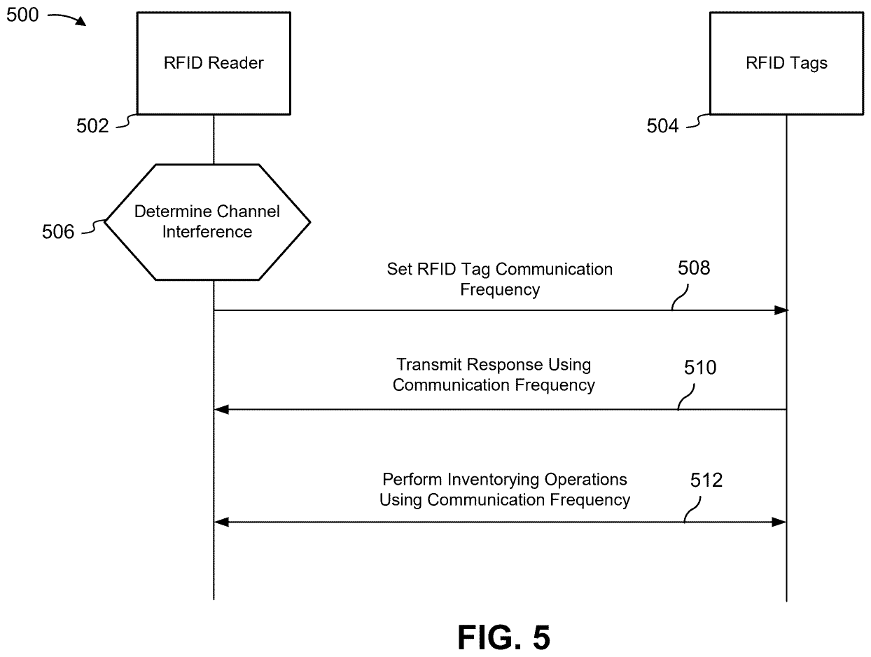

FIG. 5 is a block diagram 500 illustrating an example of communication between an IoT reader 502 and IoT tags 504 for adjusting the communication frequency between the IoT reader 502 and the IoT tags 504. The IoT reader 502 can include the RFID reader 310 of FIG. 3, one or more of the IoT readers 406 of FIG. 4, etc. The IoT tags 504 can include the RFID tag 350 of FIG. 3, the IoT tags 404 of FIG. 4, etc.

The communication between the IoT reader 502 and the IoT tags 504 can include determining channel interference (as shown at block 506). For example, the IoT reader 502 can determine an amount of interference within a channel (e.g., signal frequency range) and compare the amount of interference to an interference threshold. For example, an interference level of the channel can be determined based on a measured amount of interference in dB within the channel or frequency band occupancy of the channel.

The IoT reader 502 can transmit a first signal 508 to the IoT tags 504 to set an IoT tag communication frequency. For example, the first signal 508 can include an indicator to the IoT tags 504 to operate in a frequency hopping mode. In some examples, the first signal 508 can include a message with information associated with an output frequency for the IoT tags 504 at which to communicate with the IoT reader 502. In further examples, the IoT reader 502 can transmit one or more messages to the IoT tags 504 using the IoT tag communication frequency. For example, the separate messages can include various operations such as inventorying operations.

The IoT tags 504 can transmit a response 510 to the IoT reader 502 in reply to messages sent by the IoT reader 502 (or the first signal 508). The response by the IoT tags 504 can use the IoT tag communication frequency. For example, the IoT tags 504 can transmit an acknowledgement response indicating the IoT tags 504 are operating using the IoT tag communication frequency. In other examples, the IoT tags 504 can transmit a response including replies associated with inventorying operations, such as by transmitting IoT tag electronic product codes (EPC) in response to an inventorying action of the IoT reader 502.

Command 512 can represent performance of inventorying operations using the IoT tag communication frequency. For example, command 512 can represent a back and forth sequence of communications between the IoT reader 502 and the IoT tags 504 to perform inventorying operations. The command 512 can be transmitted using the IoT tag communication frequency.

In some examples, the IoT reader 502 can determine a change in channel interference. For example, the IoT reader 502 can monitor for channel interference and adjust the IoT tag communication based on changes. In some examples, the IoT reader 502 and the IoT tags 504 can perform inventorying actions. The IoT reader 502 can transmit a signal to the IoT tags 504 to adjust the frequency at which the IoT reader 502 and the IoT tags 504 communicate. The IoT reader 502 and the IoT tags 504 can continue performing inventorying actions using the adjusted frequency.

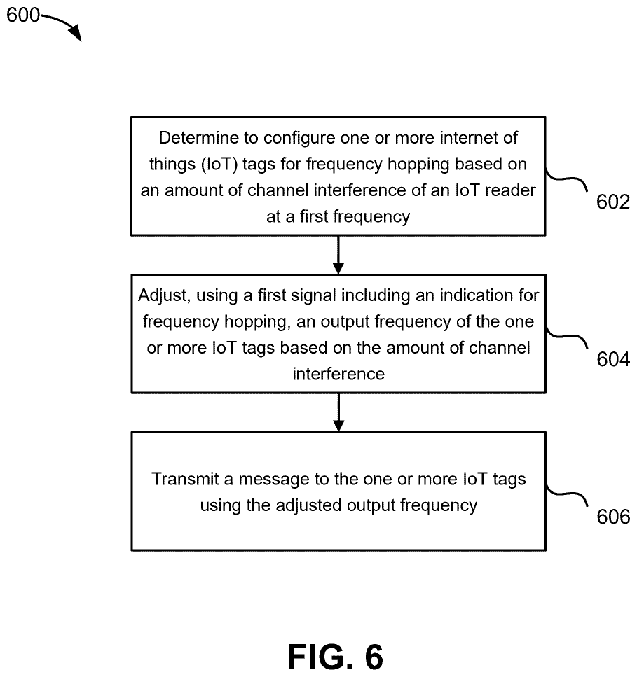

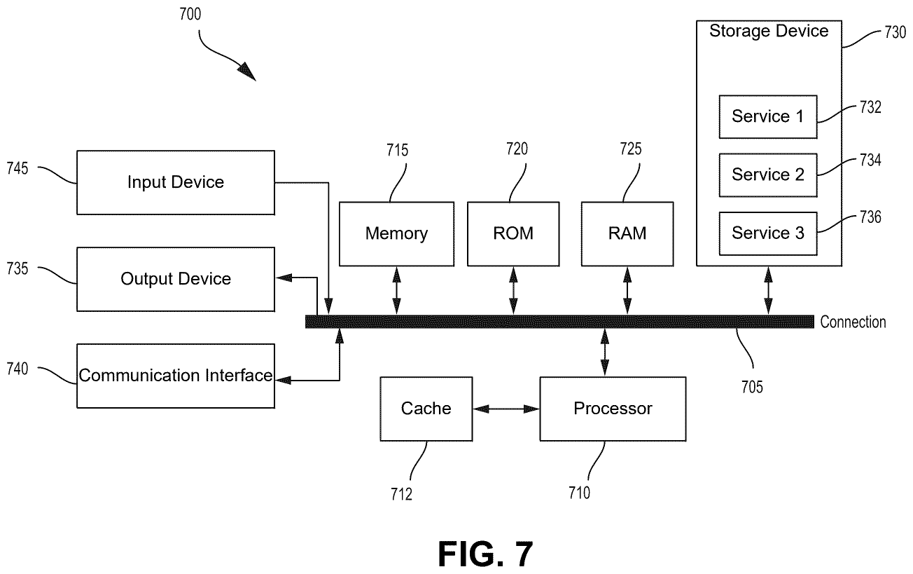

FIG. 6 is a flow diagram illustrating an example process 600 for wireless communication. In particular, the process 600 illustrates an example process of adjusting communication frequencies of IoT tags, such as including the RFID tag 350 of FIG. 3 or the IoT tags 404 described in communication with the IoT readers 406 in FIG. 4, the IoT tags 504 of FIG. 5 in communication with the IoT reader 502 of FIG. 5. The process 600 can be performed by a computing device (e.g., the computing system 170 of FIG. 1, the RFID reader 310 of FIG. 3, the IoT reader 406, 502 of FIG. 4 and FIG. 5, the computing device or computing system 700 of FIG. 7, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., processor 184 of FIG. 1, the processor 710 of FIG. 7, or other processor(s)) of the computing device. Further, the transmission and reception of signals by the computing device in the process 600 can be enabled, for example, by one or more antennas and/or one or more transceivers (e.g., wireless transceiver(s)).

At block 602, the computing device (or component thereof) can determine to configure one or more internet of things (IoT) tags for frequency hopping based on an amount of channel interference of an IoT reader at a first frequency. In some examples, the determination to configure the one or more IoT tags for frequency hopping can be in response to the amount of channel interference exceeding an interference threshold. For example, the channel interference can be based on at least one received signal strength indicator associated with one or more response from the one or more IoT tags. In such an example, the channel interference can be measured in decibels. In such an example, the computing device (or component thereof) can measure a channel interference level associated with the one or more response from the IoT tags. In some examples, the channel interference level can be an average amount of channel interference (e.g., average strength of interference) over a period of time. In other examples, the channel interference level can be a maximum detected channel interference. In further examples, the received signal strength indicator can include an average strength of a plurality of responses from the one or more IoT tags over a predetermined period of time. For example, the received signal strength indicator can indicate signal strength of the responses from the IoT tags.

In some aspects, the channel interference can include or can be based on a level of frequency band occupancy of the IoT reader. For example, frequency band occupancy can refer to a range of signal frequencies in use by a wireless communication device or other device in an environment. The computing device (or component thereof) can determine a percentage of the frequency band that is occupied and compare the percentage to an interference threshold. When the percentage of the frequency band that is occupied exceeds the threshold, the computing device (or component thereof) can adjust an output frequency of one or more IoT tags.

At block 604, the computing device (or component thereof) can adjust, using a first signal including an indication for frequency hopping, an output frequency of the one or more IoT tags based on the amount of channel interference. For example, the computing device (or component thereof) can

At block 606, the computing device (or component thereof) can transmit a message to the one or more IoT tags using the adjusted output frequency. In some aspects, the adjusted output frequency can be a set channel frequency from a plurality of predetermined channel frequencies. For example, the computing device (or component thereof) can select the adjusted output frequency from the plurality of predetermined channel frequencies based on the amount of channel interference of the IoT reader at one or more predetermined channel frequencies of the plurality of predetermined channel frequencies. In such an example, the computing device (or IoT reader and IoT tags) can be configured to output signals at a plurality of predetermined channel frequencies (e.g., a predetermined number of ranges or bands of frequencies). The computing device can iterate through the plurality of predetermined channel frequencies to determine a channel frequency with interference below an interference threshold. In some aspects, the computing device (or component thereof) can receive a response from the one or more IoT tags in reply to the message, the response using the adjusted output frequency. For example, the computing device (which can include an IoT reader) and the IoT tags can perform various communications such as inventorying operations using the adjusted output frequency. In such an example, the adjusted output frequency can be further adjusted between communications of the IoT reader and the IoT tags. In such an example, the computing device (or component thereof such as the IoT reader) can continually, on a set schedule, cycle, or upon a triggering event, measure the amount of interference associated with the output frequency (e.g., associated with a range of frequencies including the output frequency). When the amount of interference exceeds an interference threshold, the computing device can transmit a signal to the IoT tags to communicate using a further adjusted output frequency. When the amount of interference does not exceed the interference threshold, the computing device can continue to transmit signals using the adjusted output frequency.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some aspects, computing system 700 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 700 includes at least one processing unit (CPU or processor) 710 and connection 705 that communicatively couples various system components including system memory 725, such as read-only memory (ROM) 720 and random access memory (RAM) 725 to processor 710. Computing system 700 may include a cache 715 of high-speed memory connected directly with, in close proximity to, or integrated as part of processor 710.

Processor 710 may include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with the computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some aspects, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communications, comprising: at least one memory; and at least one processor coupled to the at least one memory, the at least one processor configured to: determine to configure one or more internet of things (IoT) tags for frequency hopping based on an amount of channel interference of an IoT reader at a first frequency; adjust, using a first signal including an indication for frequency hopping, an output frequency of the one or more IoT tags based on the amount of channel interference; and transmit a message to the one or more IoT tags using the adjusted output frequency.

Aspect 2. The apparatus of Aspect 1, wherein the determination to configure the one or more IoT tags for frequency hopping is in response to the amount of channel interference exceeding an interference threshold.

Aspect 3. The apparatus of any of Aspects 2 to 3, wherein the at least one processor is configured to: receive a response from the one or more IoT tags in reply to the message, the response using the adjusted output frequency.

Aspect 4. The apparatus of any of Aspects 2 to 4, wherein the channel interference is based on at least one received signal strength indicator associated with one or more response from the one or more IoT tags.

Aspect 5. The apparatus of any of Aspects 2 to 4, wherein the received signal strength indicator includes an average strength of a plurality of responses from the one or more IoT tags over a predetermined period of time.

Aspect 6. The apparatus of any of Aspects 2 to 5, wherein the channel interference is based on a level of frequency band occupancy of the IoT reader.

Aspect 7. The apparatus of any of Aspects 2 to 6, wherein the adjusted output frequency is a set channel frequency from a plurality of predetermined channel frequencies.

Aspect 8. The apparatus of any of Aspects 2 to 7, wherein the at least one processor is configured to: select the adjusted output frequency from the plurality of predetermined channel frequencies based on the amount of channel interference of the IoT reader at one or more predetermined channel frequencies of the plurality of predetermined channel frequencies.

Aspect 9. A method for wireless communications, the method comprising: determining to configure one or more internet of things (IoT) tags for frequency hopping based on an amount of channel interference of an IoT reader at a first frequency; adjusting, using a first signal including an indication for frequency hopping, an output frequency of the one or more IoT tags based on the amount of channel interference; and transmitting a message to the one or more IoT tags using the adjusted output frequency.

Aspect 10. The method of Aspect 9, wherein the determination to configure the one or more IoT tags for frequency hopping is in response to the amount of channel interference exceeding an interference threshold.

Aspect 11. The method of any of Aspects 9 to 10, further comprising: receiving a response from the one or more IoT tags in reply to the message, the response using the adjusted output frequency.

Aspect 12. The method of any of Aspects 9 to 11, wherein the channel interference is based on at least one received signal strength indicator associated with one or more response from the one or more IoT tags.

Aspect 13. The method of any of Aspects 9 to 12, wherein the received signal strength indicator includes an average strength of a plurality of responses from the one or more IoT tags over a predetermined period of time.

Aspect 14. The method of any of Aspects 9 to 13, wherein the channel interference is based on a level of frequency band occupancy of the IoT reader.

Aspect 15. The method of any of Aspects 9 to 14, wherein the adjusted output frequency is a set channel frequency from a plurality of predetermined channel frequencies.

Aspect 16. The method of any of Aspects 9 to 16, further comprising: selecting the adjusted output frequency from the plurality of predetermined channel frequencies based on the amount of channel interference of the IoT reader at one or more predetermined channel frequencies of the plurality of predetermined channel frequencies.

Aspect 17. A non-transitory computer-readable medium having stored thereon instructions that, when executed by at least one processor, cause the at least one processor to perform one or more of operations according to any of Aspects 15 to 28.

Aspect 18. An apparatus for wireless communication, the apparatus comprising one or more means for performing operations according to any of Aspects 15 to 28.

What is claimed is:

1. An apparatus for wireless communications, comprising:
at least one memory; and
at least one processor coupled to the at least one memory, the at least one processor configured to:
determine to configure one or more internet of things (IoT) tags for frequency hopping based on an amount of channel interference of an IoT reader at a first frequency;
adjust, using a first signal including an indication for frequency hopping, an output frequency of the one or more IoT tags based on the amount of channel interference; and
transmit a message to the one or more IoT tags using the adjusted output frequency.

2. The apparatus of claim 1, wherein the determination to configure the one or more IoT tags for frequency hopping is in response to the amount of channel interference exceeding an interference threshold.

3. The apparatus of claim 1, wherein the at least one processor is configured to:
receive a response from the one or more IoT tags in reply to the message, the response using the adjusted output frequency.

4. The apparatus of claim 3, wherein the channel interference is based on at least one received signal strength indicator associated with one or more response from the one or more IoT tags.

5. The apparatus of claim 4, wherein the received signal strength indicator includes an average strength of a plurality of responses from the one or more IoT tags over a predetermined period of time.

6. The apparatus of claim 1, wherein the channel interference is based on a level of frequency band occupancy of the IoT reader.

7. The apparatus of claim 1, wherein the adjusted output frequency is a set channel frequency from a plurality of predetermined channel frequencies.

8. The apparatus of claim 7, wherein the at least one processor is configured to:
select the adjusted output frequency from the plurality of predetermined channel frequencies based on the amount of channel interference of the IoT reader at one or more predetermined channel frequencies of the plurality of predetermined channel frequencies.

9. A method for wireless communications, the method comprising:
determining to configure one or more internet of things (IoT) tags for frequency hopping based on an amount of channel interference of an IoT reader at a first frequency;
adjusting, using a first signal including an indication for frequency hopping, an output frequency of the one or more IoT tags based on the amount of channel interference; and
transmitting a message to the one or more IoT tags using the adjusted output frequency.

10. The method of claim 9, wherein the determination to configure the one or more IoT tags for frequency hopping is in response to the amount of channel interference exceeding an interference threshold.

11. The method of claim 9, further comprising:
receiving a response from the one or more IoT tags in reply to the message, the response using the adjusted output frequency.

12. The method of claim 11, wherein the channel interference is based on at least one received signal strength indicator associated with one or more response from the one or more IoT tags.

13. The method of claim 12, wherein the received signal strength indicator includes an average strength of a plurality of responses from the one or more IoT tags over a predetermined period of time.

14. The method of claim 9, wherein the channel interference is based on a level of frequency band occupancy of the IoT reader.

15. The method of claim 9, wherein the adjusted output frequency is a set channel frequency from a plurality of predetermined channel frequencies.

16. The method of claim 15, further comprising:
selecting the adjusted output frequency from the plurality of predetermined channel frequencies based on the amount of channel interference of the IoT reader at one or more predetermined channel frequencies of the plurality of predetermined channel frequencies.

17. A non-transitory computer-readable medium having stored thereon instructions that, when executed by at least one processor, cause the at least one processor to:
determine to configure one or more internet of things (IoT) tags for frequency hopping based on an amount of channel interference of an IoT reader at a first frequency;
adjust, using a first signal including an indication for frequency hopping, an output frequency of the one or more IoT tags based on the amount of channel interference; and
transmit a message to the one or more IoT tags using the adjusted output frequency.

18. The non-transitory computer-readable medium of claim 17, wherein the determination to configure the one or more IoT tags for frequency hopping is in response to the amount of channel interference exceeding an interference threshold.

19. The non-transitory computer-readable medium of claim 17, wherein the non-transitory computer-readable medium includes further instructions, that when executed by the at least one processor, cause the at least one processor to:
receive a response from the one or more IoT tags in reply to the message, the response using the adjusted output frequency.

20. The non-transitory of computer-readable medium of claim 19, wherein the channel interference is based on at least one received signal strength indicator associated with one or more response from the one or more IoT tags.
